(19) United States
(12) Patent Application Publication
(10) Pub. No.: US 2007/0107487 A1
(43) Pub. Date: May 17, 2007

(54) A CALIBRATION SYSTEM

(75) Inventors: Kartik B. Ariyur, Minnetonka, MN (US); Anoop K. Mathur, Shoreview, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/163,693

(22) Filed: Oct. 27, 2005

(51) Int. Cl. G01D 18/00

(52) U.S. Cl. 73/1.01; 702/104

(57) ABSTRACT

A system for self-calibration and self-tuning of sensors. The sensors may be calibrated statically and dynamically. The calibration may be automatic. Static calibration may be performed via a slope seeking loop. Dynamic calibration may be performed with both the slope seeking loop and a variation of the slope seeking set point.

### BACKGROUND

The invention pertains to sensors. Particularly, the invention pertains to calibration of sensors, and more particularly to self calibration of sensors.

### SUMMARY

The invention is a system for static and dynamic calibration of sensors.

### BRIEF DESCRIPTION OF THE DRAWING

FIG. 1 is a flow diagram of a calibration system;

FIG. 2 is a block diagram of a calibration system; and

FIG. 3 is a graph of an operating curve.

### DESCRIPTION

A system may exist for the automation of static and dynamic calibration for a certain class of sensors. Static calibration may be performed via a slope seeking loop or algorithm. Dynamic calibration may be performed with both the slope seeking loop and a variation of the slope seeking set point.

The system may remove a need for manual adjustment of sensors to account for sensor drift due to ambient condition changes, and also the need for recalibration for operating condition changes. This may be significant if the sensors are wireless and there is a desire to minimize the need for manual adjustments.

The sensors may retain accuracy under changing ambient conditions and also recalibrate themselves to adjust to operating conditions and sensor aging. This may be done through using feedback control via sensing of the ambient conditions and the operating conditions.

A drift control feedback loop may be designed using identified empirical or semi-empirical constitutive models of sensor material. Similarly, a feedback loop may sense changes in operating conditions and use either a lookup table or a sensor model to change the gains at the sensor output.

Self-calibration of the sensors may be compelling for one or more of the following reasons. Accurate sensor calibration is time-consuming, expensive, and often manual. Aging of sensor parts compels periodic recalibration. Changes of operating conditions also necessitate recalibration. Sensor accuracy is compromised when operating conditions are not same as the calibration conditions. It is difficult to manufacture affordable sensors that do not need calibration or recalibration.

Self-tuning of the sensors may be compelling for one or more of the following reasons. The settling time of a sensor is different at various calibration points. The manufacture of sensors with uniform setting times is typically unaffordable. Thus, sensors generally require specific settings of calibration points. Aging and changes of operating conditions may change the settling time.

There may be a large class of or many sensors that transduce a difference between a control signal and an environmental signal to produce an output (typically electrical). Examples may include microphones, flow control valves, thermocouples, gimbaled mechanisms, and other relative-type measuring devices.

The present approach may be to adapt the operating point of a sensor for self-calibration. There is no need to do multiple sensors. A rough estimate of the operating curve may serve to eliminate individual calibration of manufactured sensors. The accuracy of a sensor may be well characterized through knowledge of the uncertainty in the transducer dynamics. Slope seeking is a key to an application of the present system.

The system may reduce sensor costs with the elimination or reduction of calibration tasks. The automatic calibration mechanism may be autonomous from the subject sensors.

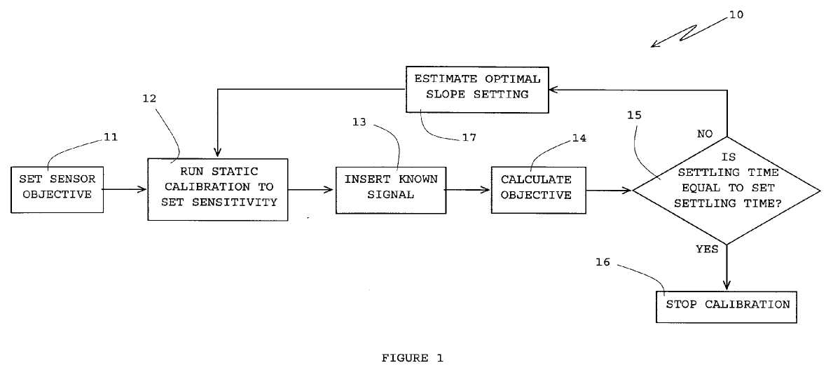

FIG. 1 is a basic flow diagram of self-calibration and tuning system 10 for a sensor. An objective for a sensor to be calibrated may be represented by a “set sensor objective” block 11. An objective setting from block 11 may go to a block 12 to run a static calibration to set sensitivity. An output of block 12 may go through an “insert a known signal” block 13. The output with an inserted known signal from block 13 may go to a “calculate an objective” block 14. An output of block 14 may be a calibration result of a settling time of the sensor. This output may go to a decision diamond 15 which determines whether the settling time of the sensor is approximately equal to the set or required setting time. If the answer is “yes”, then an output from diamond 15 may go to a block 16 to stop the calibration. If the answer is “no”, then an output from diamond 15 may go to a block 17 for an estimate of an optimal slope setting. An estimate of the optimal slope setting may go to the block 12 for a static calibration run to set the sensitivity of the sensor. That sensitivity setting may have a known signal inserted from block 13. The resultant signal may go on to the “calculate objective” block 14. The output from block 14 may be a new settling time compared to the set or predetermined settling time for the sensor at diamond 15. If the settling times are not equal, then the system 10 may proceed again through blocks 17, 12, 13 and 14 for a settling time to approach or equal the settling time as prescribed. This cycle through blocks 17, 12, 13, and 14, and diamond 15 may repeat until the settling time is at least approximately equal to the set settling time. If the latter equality is attained, then the calibration may be stopped as indicated by block 16.

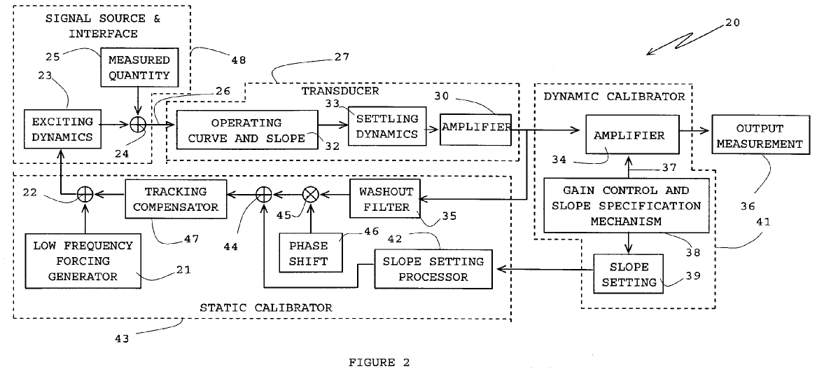

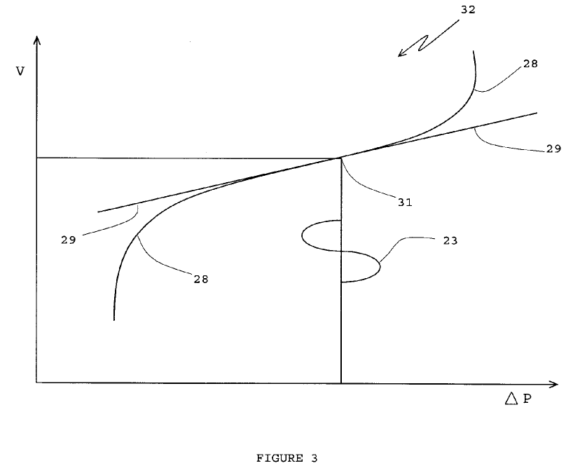

FIG. 2 is a block diagram of a system 20. Block 21 may represent a generator source of low frequency forcing relative to transducer dynamics of a sensor being calibrated and tuned. The generator source 21 may output a signal as represented by asinωt. The output signal of tracking compensator 47 may go to an adder or summer 22 where the signal may be combined with a perturbation from generator source 21. The signal from adder 22 may provide a commanded input to set the slope through the exciting dynamics (Fᵢ(s)) 23 to an adder or summer 24. Also coming into a summer 24 may be a measured quantity 25. The quantity 25 may be utilized for self-calibrating of a transducer 27 of a sensor when it is fairly static. The output 26 of adder 24, including the output of exciting dynamics 23 and the measured quantity 22, may go to the transducer 27. Exciting dynamics 23, measured quantity 25 and adder 24 may constitute a transducer signal source and interface module 48. The characteristics of transducer 27 may be represented by an operating curve 28 with a slope shown by a tangent 29 on the curve 28, which is at a calibration point 31, as shown in FIG. 3.

FIG. 3 is a graph 32 revealing the operating curve 28 and slope 29 of the transducer 27. The waveform represents the exciting dynamics 23. The ordinate axis represents a transducer voltage and the abscissa axis represents ΔP (delta pressure in the transducer). The output of the characteristics block 32 of FIG. 2, which is represented by the graph 32 of FIG. 3, may go to a settling dynamics (Fₒ(s)) block 33.

In FIG. 2, the output of settling dynamics 33 may go through an amplifier 30. An output of amplifier 30, which may be the output of transducer module 27, may go to an amplifier 34 and a washout filter 35. The settling dynamics 33 may provide an output with an operating point on a required slope with a settling time. The operation may be achieved via a slope seeking algorithm and a settling time algorithm. The settling time algorithm may be a gradient descent or bisection algorithm. The output from dynamics 33 via amplifier 30 of transducer 27 may be to the variable gain K₁ amplifier 34. An output 36 of the measurement by the sensor may be provided by amplifier 34. Amplifier 34 may have a gain control input 37 with a signal for controlling the gain K₁ of amplifier 34. The gain control signal 37 may come from a gain control and slope specification mechanism block 38. Another output of block 38 may be a commanded or specified slope f′_{ref} at calibration point 31. Components 34, 38, and 39 may constitute a dynamic calibration module 41 to optimize the settling time of the transducer 27. The equations relating to mechanism 38 may indicate a relationship between slope, settling time, and amplifier gain over time steps. These equations may include
f′_{ref}(k+1)=f′_{ref}(k)+g₁(τₛ(k)), and
K₁(k+1)=K₁(k)+g₂(τₛ(k)).

“k+1” and “k” indicate time steps. “τₛ” indicates settling time, “g₁” and “g₂” indicate a function of settling time relative to the set slope f′_{ref} and amplifier gain K₁, respectively.

A set slope f′_{ref} 39 may be sent as an input to a slope setting processor 42 of a slope seeker for static calibration module 43. For the same sensitivity, the product of K₁ and f′_{ref} may be a constant. The slope setting processor 42 may reflect the following equation,
−(a/2)R{e^{-jφ}jωFₒ(jω)Cₒ(jω)Fᵢ(jω)}.

“a” may indicate a magnitude, “R” may indicate the real part, Fᵢ may indicate the exciting dynamics, Fₒ may indicate the settling dynamics, and Cₒ may indicate the washout filter (if ω is small, Fᵢ(jω) and Fₒ(jω) behave as constant gains). The slope setting processor 42 may output a slope setting to a summer or adder 44. An output of washout filter sCₒ(s) 35 may multiplied with a phase shift signal 46 represented by sin(ωt−φ), at multiplier 45. The output of multiplier 45 may go to adder 44 where it is summed with the slope setting from processor 42. The output of adder 44 may include a signal representing a tracking error which is proportional to the difference between where one is and where one should be. This output of adder 44 may go to a tracking compensator 47 which may have a signal transformation aspect that is represented by Cᵢ(s)/s. The output of compensator 47 may be a setting signal that goes to adder 22 to be combined with the perturbation signal from the low frequency forcing generator 21. The forcing may be an additive to the input of the exciting dynamics 23. The sinusoidal signal may be added to perturb the current setting. The output path of adder 22, along with the other processes, may be noted above.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

1. A self calibrating and tuning system comprising:
setting a settling time;
running a static calibration of a sensor to obtain a particular sensitivity;
measuring the settling time of the sensor;
comparing the measured settling time with the set settling time; and
if the measured settling time is approximately equal to the set settling time, then stop the calibration; and
if the measured settling time is not approximately equal to the set settling time, then an estimating a new sensitivity of the sensor is made and the steps of this claim may be repeated.

2. The system of claim 1, further comprising setting a sensor objective of a particular sensitivity before running the static calibration of a sensor.

3. The system of claim 2, further comprising inserting a known signal subsequent to running a static calibration.

4. A self-calibrating and tuning system comprising:
measuring a quantity by a transducer;
adding exciting dynamics to the measured quantity; and
operating the transducer on an operating curve and slope of an electrical signal versus a delta parameter having an output including settling dynamics.

5. The system of claim 4, further comprising: amplifying the output of the transducer with a variable gain; and outputting a measurement.

6. The system of claim 5, wherein the outputted measurement is a calibrated measurement.

7. The system of claim 6, further comprising a gain control and slope specification mechanism having a variable gain output for the amplifying the output of the transducer.

8. The system of claim 7, further comprising a slope setting output from the gain control and slope specification mechanism.

9. The system of claim 8, further comprising:
connecting the output of the transducer to a filter; and
affecting an output of the filter with a phase shift.

10. The system of claim 9, further comprising adding a slope setting output from the gain control and slope specification mechanism to a phase shift affected output from the filter for a compensated slope setting.

11. The system of claim 10, further comprising tracking compensation of the compensated slope setting to be added to an output of a low frequency forcing generator to be summed for an input to the exciting dynamics.

12. A system for static and dynamic calibration, comprising:
a transducer;
a transducer signal source connected to the transducer;
a static calibration module connected to the transducer and the transducer signal source; and
a dynamic calibration module connected to the transducer and the static calibration module.

13. The system of claim 12, wherein the transducer is operable relative to an operating curve and a slope setting.

14. The system of claim 13, wherein the dynamic calibration module comprises:
an amplifier having a first input connected to an output of the transducer; and
a gain control and slope specification mechanism having a first output connected to a second input of the amplifier.

15. The system of claim 14, wherein the static calibration module comprises:
a slope setting processor having an input connected to a second output of the gain control and slope specification mechanism;
a filter connected to the output of the transducer;
a compensator having an input connected to a combination of an output of the slope setting processor and an output of the filter; and
a generator having an output combined with an output of the compensator to provide an output of the static calibration module.

16. The system of claim 15, wherein the transducer signal source comprises:
a measured quantity submodule; and
an exciting dynamics submodule having an input connected to the output of the static calibration module; and
wherein an output of the measured quantity submodule is combined with an output of the exciting dynamics submodule to provide an input to the transducer module.

17. The system of claim 16, wherein:
the compensator is a tracking compensator; and
the generator is a low frequency forcing generator.

18. The system of claim 17, further comprising:
a phase shift signal generator having an output combined with the output of the filter; and
wherein the filter is a washout filter.

19. The system of claim 18, wherein:
the first output of the gain control and slope specification mechanism is an amplifier gain signal for an amplifier gain; and
the second output of the gain control and slope specification mechanism is a signal for the slope setting.

20. The system of claim 19, wherein a product of the amplifier gain and the slope setting is maintained at an approximately constant value.
